(19) United States
(12) Patent Application Publication
(10) Pub. No.: US 2024/0264381 A1
(43) Pub. Date: Aug. 8, 2024

(54) OPTICAL SWITCH AND OPTICAL SWITCH SYSTEM

(71) Applicant: NIPPON TELEGRAPH AND TELEPHONE CORPORATION, Tokyo (JP)

(72) Inventors: Tatsuya FUJIMOTO, Musashino-shi, Tokyo (JP); Chisato FUKAI, Musashino-shi, Tokyo (JP); Tomohiro KAWANO, Musashino-shi, Tokyo (JP); Hiroshi WATANABE, Musashino-shi, Tokyo (JP); Kazuhide NAKAE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/291,569

(22) PCT Filed: Aug. 6, 2021
(86) PCT No.: PCT/JP2021/029430

§ 371 Date: Jan. 23, 2024

(51) Int. Cl. G02B 6/35

(52) U.S. Cl. CPC G02B 6/3504

(57) ABSTRACT

An object of the present disclosure is to provide an optical switch that does not require power supply. The present disclosure provides an optical switch which includes: a light driving rotation unit including: a light-expansion body which expands by irradiating light and contracts by interrupting light; a knock rod for converting expansion/contraction of the light-expansion body into reciprocating linear motion by a constant distance; and a rotary motion body for correspondingly converting reciprocating linear motion by the constant distance of the knock rod into rotating rotary motion by a constant angle; and a optical switching rotation unit including: a first optical connector to which one switching object optical fiber is fixed; a second optical connector to which an optical fiber of a switching object optical fiber group is respectively fixed; and a connecting rotor for rotating around an axis in synchronization with rotation converted by the rotary motion body, and for switching/connecting one switching object optical fiber fixed to the first optical connector in contact with one end face and one optical fiber in the switching object optical fiber group fixed to the second optical connector in contact with other end face

### TECHNICAL FIELD

The present disclosure relates to an optical switch and an optical switch system used for switching an optical path.

### BACKGROUND ART

Various methods have been proposed for an all-optical switch for switching paths of light as they are (see, for example, NPL 1). Of the optical switches, optical fiber type mechanical optical switches that control aligning of optical fibers or optical connectors by robot arms, motors, or the like are inferior to other systems in terms of a low switching speed, but are superior to the other systems in terms of low loss, low wavelength dependency, a multi-port property, and a self-holding function of holding a switching state when power is lost.

As typical structures, for example, there are a scheme of moving a stage using optical fiber V-shaped grooves in parallel, a scheme of selectively coupling a plurality of optical fibers emitted from incident optical fibers by moving or changing an angle of a mirror or a prism in parallel, and a scheme of connecting a jumper cable with an optical connector using a robot arm.

### CITATION LIST

### Non Patent Literature

[NPL 1] M. Stepanovsky, “A Comparative Review of MEMS-Based Optical Cross-Connects for All-Optical Networks From the Past to the Present Day,”IEEE Communications Surveys & Tutorials, vol. 21, no. 3, pp. 2928-2946, 2019.

### SUMMARY OF INVENTION

### Technical Problem

However, the optical path switching described in NPL 1 has a problem that it is difficult to more reduce the power consumption and size, and to more economize. Concretely, in the above scheme of moving the stage using optical fiber V-shaped grooves or the prism in parallel generally uses a motor as a driving source, a certain level of torque or more is necessary for the motor due to a mechanism that directly move a weight object such as the stage, requiring power consumption for obtaining a corresponding output to maintain the necessary torque.

Further, since the optical axis alignment using the single mode optical fiber requires accuracy of about 1 μm or less, when a mechanism for converting the rotary motion of the motor into linear motion, such as a ball screw is used, it is necessary to convert into linear motion of sub μm steps. An optical fiber pitch of an optical fiber array on an output side which is usually used is about 125 μm which is a cladding outer diameter of an optical fiber or 250 μm which is the cladding outer diameter of the optical fiber.

When the number of optical fibers to be installed is increased while maintaining the pitches of the optical fibers, the optical fiber array on the output side becomes large. As a result, the distance of the linear motion is extended, the actual driving time of the motor must be extended, there is a problem that the power consumption is increased. Therefore, such an optical fiber type mechanical optical switch generally requires electric power of several hundred mW or more. In addition, the robot arm system using an optical connector requires a large electric power of several tens W or more for the robot arm itself for controlling the insertion and extraction of the optical connector or the ferrule. In an environment where power supply is difficult such as an outdoor overhead optical connection point, it is difficult to secure power sufficient to drive these optical switches.

In order to solve the above problem, the present disclosure aims to provide an optical switch that does not require power supply, and an optical switch system that operates with low power consumption by using the optical switch.

### Solution to Problem

In order to solve the above problem, the optical switch of the present disclosure uses a light-expansion body which expands and contracts by irradiation/interruption of light, and is configured to generate rotary motion from linear motion and to switch/connect the optical fiber by the rotary motion.

Specifically, the present disclosure provides an optical switch having a light driving rotation unit includes a light-expansion body which expands by irradiating light and contracts by interrupting light; a knock rod for converting expansion/contraction of the light-expansion body into reciprocating linear motion by a constant distance; and a rotary motion body for correspondingly converting reciprocating linear motion by the constant distance of the knock rod into rotating rotary motion by a constant angle; and a optical switching rotation unit includes a first optical connector to which one switching object optical fiber is fixed; a second optical connector to which an optical fiber of a switching object optical fiber group is respectively fixed; and a connecting rotor for rotating around an axis in synchronization with rotation converted by the rotary motion body, and for switching/connecting one switching object optical fiber fixed to the first optical connector in contact with one end face and one optical fiber in the switching object optical fiber group fixed to the second optical connector in contact with other end face.

With such a structure, the optical switch of the present disclosure can be configured to be in no need of power supply.

Further, in the optical switch of the present disclosure, the rotary motion body includes: a rotor for rotating around an axis within a housing; a rotor gear fixed to side face of the rotor, and for transmitting the rotation of the rotor; a blade fixed to end face of the knock rod side of the rotor, and having a tip with a flat slope at the knock rod side; a cylindrical-shaped cam fixed to within the housing, having a slope of a sawtooth groove with an annular shape provided to an end face of the cylindrical-shaped blade side, and receiving the slope of the blade with the slope which has inclination of the same direction as the slope of the blade; and an elastic body fixed to the housing, and pressing back the rotor toward the cam; and the knock rod for reciprocating in the cylindrical-shaped inside of the cam and including a sawtooth groove at the end face of the blade side with an annular shape, which is shifted by a half pitch at the same period as the sawtooth groove of the cam, and has a slope inclined in the same direction as the slope of the blade; where when the light-expansion body contracts, the slope of the blade is pressed against on the slope of the sawtooth groove of the cam by the elastic body; when the light-expansion body expands, the knock rod progresses toward the rotor, the slope of the sawtooth groove of the knock rod is pressed against the slope of the blade, and the pressed slope of the blade slides on the slope of the teeth of the sawtooth groove of the knock rod, thereby the rotor rotates; and when the light-expansion body shifts from expansion to contraction, the knock rod retreats from the rotor, the rotor pressed back by the elastic body goes to the cam, the slope of the blade is pressed against the slope of the sawtooth groove of the cam, and the pressed slope of the blade slides on the slope of the teeth of the sawtooth groove of the cam, thereby the rotor rotates.

Further, in the optical switch of the present disclosure, the light-expansion body is made of a black material or a material containing air bubbles therein.

Further, in the optical switch of the present disclosure, the connecting rotor including: a connecting rotor gear for rotating around an axis according to the rotary motion converted by the rotary motion body; and a connecting optical path for connecting a rotation center of one end face perpendicular to the axis and a connecting point arranged on a circumference having a radius of a predetermined distance from the rotation center of other end face perpendicular to the axis; where the first optical connector is in contact with one end face of the connecting rotor, and fixes the one switching object optical fiber to a position opposed the rotation center of the connecting rotor; and the second optical connector is in contact with other end face of the connecting rotor, and respectively fixes an optical fiber in the switching object optical fiber group on a circumference having a radius of a predetermined distance from the rotation center of the connecting rotor; where when the connecting rotor rotates, the connecting optical path switches/connects the one switching object optical fiber of the first optical connector and one optical fiber in the switching object optical fiber group of the second optical connector.

Further, in the optical switch of the present disclosure, more includes a monitoring rotation unit which rotates in synchronization with the rotation of the rotary motion body and detects an angle of rotation of the connection rotor.

Further, in the optical switch of the present disclosure, the monitoring rotation unit including: a first monitoring rotor rotates around an axis according to the rotary motion converted by the rotary motion body, and has a plurality of monitoring optical paths which connect one end face perpendicular to the axis and other end face perpendicular to the axis and in which connection/interruption patterns are different depending on the angle of the rotation; a third optical connector which is in contact with one end face of the first monitoring rotor, and fixes a plurality of monitoring transmission optical fibers for transmitting monitoring light; and a fourth optical connector which is in contact with other end face of the first monitoring rotor, and fixes a plurality of monitoring reception optical fibers for receiving monitoring light; where when the first monitoring rotor rotates, connection/interruption patterns of each light from the plurality of monitoring transmission optical fibers to the plurality of monitoring reception optical fibers uniquely change.

Further, in the optical switch of the present disclosure, the monitoring rotation unit including: a second monitoring rotor which rotates around the axis according to the rotary motion converted by the rotary motion body, and has a reflection plate, at one end face perpendicular to the axis, whose reflection/interruption patterns are different depending on an angle of the rotation; and a fifth optical connector which is in contact with one end face of the second monitoring rotor, and fixes a plurality of monitoring transmission/reception optical fibers for transmitting/receiving the monitoring light; where
when the second monitoring rotor rotates, reflection/non-reflection patterns uniquely change of each light in the plurality of monitoring transmission/reception optical fibers.

In order to solve the above problem, the optical switch system of the present disclosure uses a light-expansion body which expands/contracts by irradiation/interruption of light from a control device, generates rotary motion from linear motion, and switches and connects optical fibers by the rotary motion.

Specifically, the present disclosure provides an optical switch system which includes the optical switch described in above any one embodiment and a control device includes a driving light source for supplying light causing the light-expansion body to expand and a control unit for instructing irradiation/interruption to the driving light source.

With such a structure, the optical switch system of the present disclosure can operate with low power consumption because of the use of an optical switch that does not require power supply.

The above inventions can be combined as much as possible.

### Advantageous Effects of Invention

According to the present disclosure, it is possible to provide an optical switch that does not require power supply and operates with low power consumption, and an optical switch system using the optical switch.

### BRIEF DESCRIPTION OF DRAWINGS

FIG. 1 is a diagram illustrating a configuration of the optical switch system of the present disclosure.

FIG. 2 is a diagram illustrating a configuration of the optical switch of the present disclosure.

FIG. 3 is a diagram illustrating a configuration of the light driving rotation unit of the present disclosure.

FIG. 4 is a diagram illustrating a configuration of the light-expansion body of the present disclosure.

FIG. 5A is a diagram illustrating a configuration of the knock rod of the present disclosure.

FIG. 5B is a diagram illustrating a configuration of the knock rod of the present disclosure.

FIG. 6A is a diagram illustrating a configuration of the cam of the present disclosure.

FIG. 6B is a diagram illustrating a configuration of the cam of the present disclosure.

FIG. 7A is a diagram illustrating a configuration of the housing of the present disclosure.

FIG. 7B is a diagram illustrating a configuration of the housing of the present disclosure.

FIG. 8A is a diagram illustrating a configuration of the rotary motion body of the present disclosure.

FIG. 8A is a diagram illustrating a configuration of the rotary motion body of the present disclosure.

FIG. 9 is a diagram illustrating an operation of the light driving rotation unit of the present disclosure.

FIG. 10 is a diagram illustrating an operation of the light driving rotation unit of the present disclosure.

FIG. 11 is a diagram illustrating an operation of the light driving rotation unit of the present disclosure.

FIG. 12A is a diagram illustrating a configuration of the optical switching rotation unit of the present disclosure.

FIG. 12A is a diagram illustrating a configuration of the optical switching rotation unit of the present disclosure.

FIG. 13A is a diagram illustrating a configuration of the monitoring rotation unit of the present disclosure.

FIG. 13B is a diagram illustrating a configuration of the monitoring rotation unit of the present disclosure.

FIG. 13C is a diagram illustrating a configuration of the monitoring rotation unit of the present disclosure.

FIG. 14 is a diagram illustrating a configuration of the optical switch system of the present disclosure.

FIG. 15 is a diagram illustrating a configuration of the optical switch of the present disclosure.

FIG. 16A is a diagram illustrating a configuration of the monitoring rotation unit of the present disclosure.

FIG. 16B is a diagram illustrating a configuration of the monitoring rotation unit of the present disclosure.

FIG. 16C is a diagram illustrating a configuration of the monitoring rotation unit of the present disclosure.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

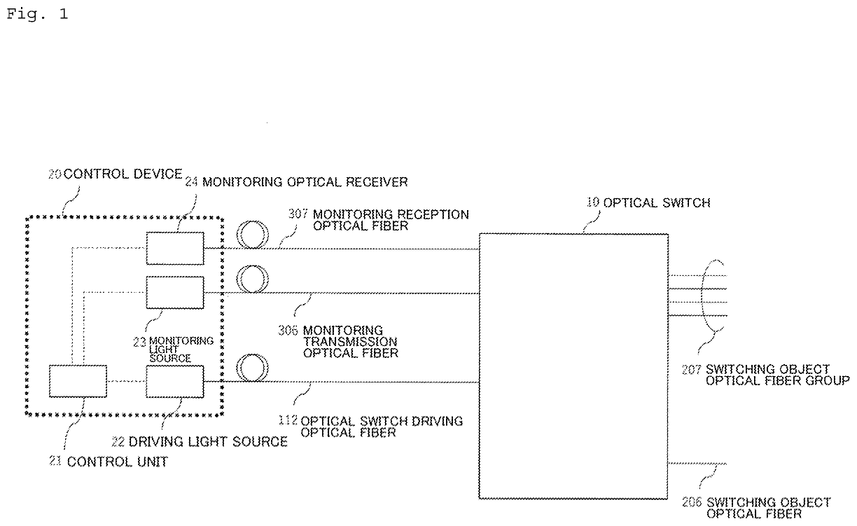

A configuration of the optical switch system of the present disclosure is shown in FIG. 1. In FIG. 1, reference numeral 10 denotes an optical switch, 112 denotes an optical switch driving optical fiber, 20 denotes a control device, 21 denotes a control unit, 22 denotes a driving light source, 23 denotes a monitoring light source, 24 denotes a monitoring light receiver, 206 denotes a switching object optical fiber, 207 denotes a switching object optical fiber group, 306 denotes a monitoring transmission optical fiber, and 307 denotes a monitoring reception optical fiber.

The optical switch system includes the optical switch 10 and the control device 20. The control device 20 includes the control unit 21 and the driving light source 22. The control device 20 may further include the monitoring light source 23 and the monitoring optical receiver 24.

The control unit 21 instructs the driving light source 22 to irradiate/interrupt the light for driving. The driving light source 22 supplies driving light to the optical switch 10 through the optical switch driving optical fiber 112. The optical switch 10 switches and connects the switching object optical fiber 206 and one optical fiber in the switching object optical fiber group 207 by irradiating/interrupting the light of the driving light source 22. The optical switch 10 does not use a power source, and is controlled by the light transmitted from the control device 20 capable of using the power source via the optical switch driving optical fiber 112.

The control unit 21 causes the monitoring light source 23 to transmit monitoring light. The monitoring light source 23 supplies the monitoring light to the optical switch 10 through the monitoring transmission optical fiber 306. The monitoring optical receiver 24 receives the monitoring light from the optical switch 10 through the monitoring reception optical fiber 307. The control unit 21 receives a reception signal from the monitoring optical receiver 24 and monitors whether the optical switch 10 is operated as instructed.

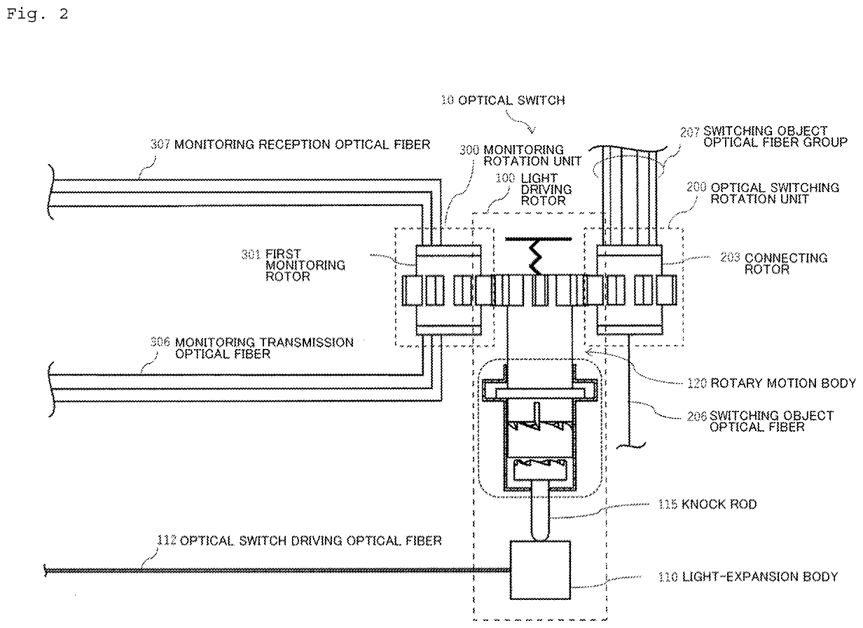

The structure of the optical switch of the present disclosure is shown in FIG. 2. In FIG. 2, reference numeral 10 denotes an optical switch, 100 denotes a light driving rotation unit, 110 denotes a light-expansion body, 112 denotes an optical switch driving optical fiber, 115 denotes a knock rod, 120 denotes rotary motion body, 200 denotes an optical switching rotation unit, 203 denotes a connecting rotor, 206 denotes a switching object optical fiber, 207 denotes a switching object optical fiber group, 300 denotes a monitoring rotation unit, 301 denotes a first monitoring rotor, 306 denotes a monitoring transmission optical fiber, and 307 denotes a monitoring reception optical fiber. The optical switch 10 includes a light driving rotation unit 100 and a optical switching rotation unit 200. Further, a monitoring rotation unit 300 may be provided. By the way, in FIG. 2, the inside of the housing is seen through only the inside of the dotted line of the light driving rotation unit 100.

The light-expansion body 110 of the light driving rotation unit 100 is irradiated with driving light through the optical switch driving optical fiber 112, subsequently, when the driving light is interrupted, the light-expansion body 110 is expanded/contracted according to the irradiation/interruption. The knock rod 115 converts the expansion/contraction of the light-expansion body 110 into linear motion reciprocating by a just constant distance. The rotary motion body 120 in the light driving rotation unit 100 converts the linear motion of the knock rod 115 into rotary motion that rotates by a just constant angle. The rotation is transmitted to the optical switching rotation unit 200, and the connecting rotor 203 in the optical switching rotation unit 200 rotates, thereby switching and connecting one of the switching object optical fiber group 207 and the switching object optical fiber 206.

When the optical switch includes the monitoring rotation unit 300, if the rotary motion body 120 of the light driving rotation unit 100 converts into rotary motion that rotates by a constant angle, the rotation is transmitted to the monitoring rotation unit 300, and the first monitoring rotor of the monitoring rotation unit 300 rotates by a constant angle. When light is input to the monitoring rotation unit 300 from the monitoring transmission optical fiber 306, the rotation angle of the connecting rotor 203 in the optical switching rotation unit 200 can be detected depending on how the light is connected/interrupted and input to the monitoring reception optical fiber 307. Therefore, the control device 20 can monitor whether the optical switch 10 switches and connects between the switching object optical fiber 206 and which optical fiber in the switching object optical fiber group 207 as instructed.

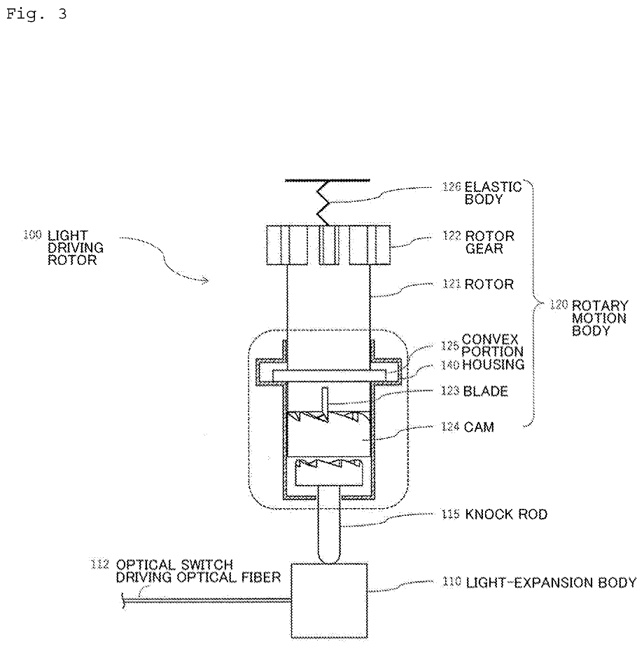

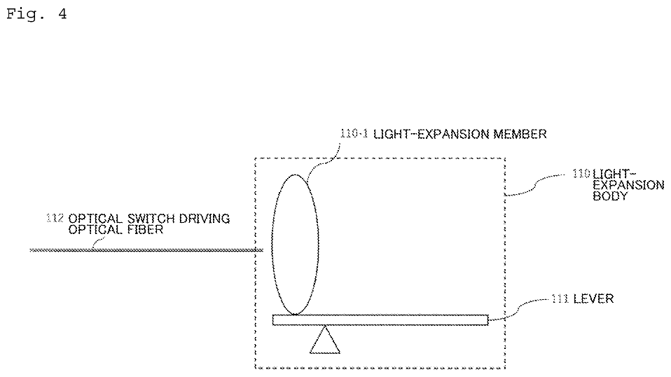

The configuration of the light driving rotation unit of the present disclosure is shown in FIG. 3. Each configuration of the light-expansion body, knock rod, cam, housing, and rotary motion body that the optical drive rotation unit includes of the present disclosure shown in FIGS. 4 to 8B. In FIGS. 3 to 8B, reference numeral 100 denotes a light driving rotation unit, 110 denotes an light-expansion body, 110-1 denotes a light-expansion member, 111 denotes a lever, 112 denotes an optical switch driving optical fiber, 115 denotes a knock rod, 115-1 denotes a groove of the knock rod, 115-2 denotes a pressing unit, 120 denotes rotary motion body, 121 denotes a rotor, 122 denotes a rotor gear, 123 denotes a blade, 124 denotes a cam, 124-1 denotes a groove of the cam, 124-2 denotes a knock hole of the cam, 125 denotes a convex potion, 126 denotes an elastic body, 127 denotes an axis hole, 140 denotes a housing, 141 denotes a rotor hole, 142 denotes a concave portion, and 143 denotes a knock hole of the housing. In FIG. 3, the inside of the housing 140 is seen through only the inside of the dotted line of the light driving rotation unit 100.

In FIG. 3, the light-expansion body 110 expands when irradiated with driving light supplied from the optical switch driving optical fiber 112, and contracts when blocked. The material of the light-expansion body 110 is a member which expands when light is irradiated and contracts when the light is interrupted. For example, the material susceptible to expansion includes polymer molecules. It is desirable that a black material, for example, charcoal, is kneaded into an easily expandable material such as a polymer molecule. The light is easily converted into heat by irradiating the black substance with light. By transferring the heat to the polymer of the black substance, the polymer undergoes thermal expansion. Further, the thermal expansion of air may be utilized by using a foam polymer containing air bubbles therein.

The configuration example of the light-expansion body is shown in FIG. 4. In order to occur a large change due to thermal expansion, expansion and contraction of the light-expansion member 110-1 may be amplified by using the lever 111 as shown in FIG. 4.

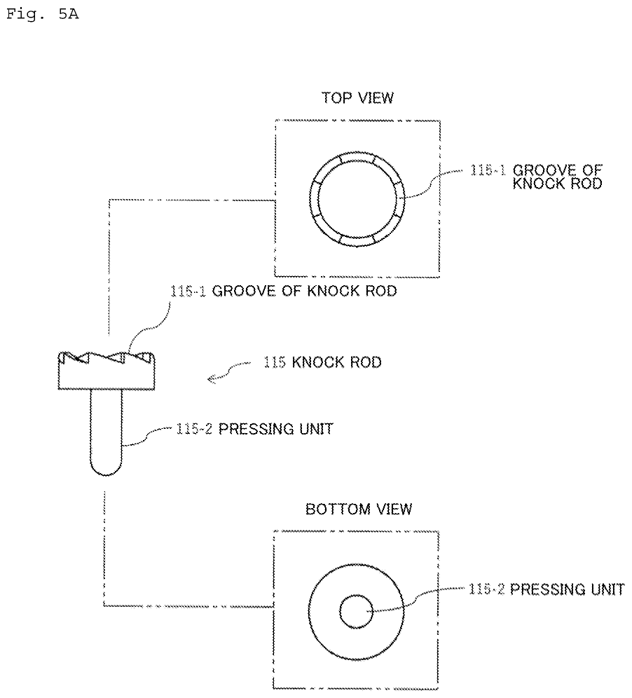

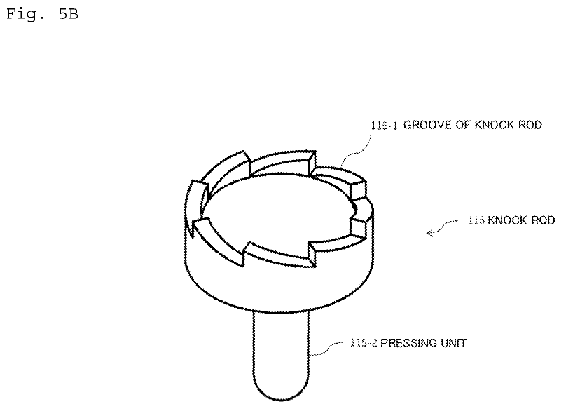

Examples of the configuration of the knock rod are shown in FIGS. 5A and 5B. FIG. 5A is a front view, a top view and a bottom view of the knock rod, and FIG. 5B is a perspective view of the knock rod. In FIGS. 3, 5A and 5 B, the pressing unit 115-2 of the knock rod 115 converts into the linear motion reciprocating by a constant distance inside the knock hole 124-2 of the cam in accordance with the expansion and contraction of the light-expansion body 110. Specifically, the knock rod 115 has a groove 115-1 of the knock rod in an annular shape on the end face on the side of the blade 123. The groove 115-1 of the knock rod has a saw-tooth shape. The period of the groove 115-1 of the knock rod is the same as that of the groove 124-1 of the cam 124, and is shifted by a half pitch. The slope of the groove 115-1 of the knock rod receives the blade 123 when pushing up the rotor 121, so that the slope has an inclination in the same direction as the slope of the blade 123.

The rotary motion body 120 correspondingly converts the linear motion of the knock rod 115 reciprocating by a constant distance into rotary motion of rotating by a constant angle. Specifically, the rotary motion body 120 includes the rotor 121, the rotor gear 122, blades 123, the cam 124, the convex portion 125, the elastic body 126, and the housing 140.

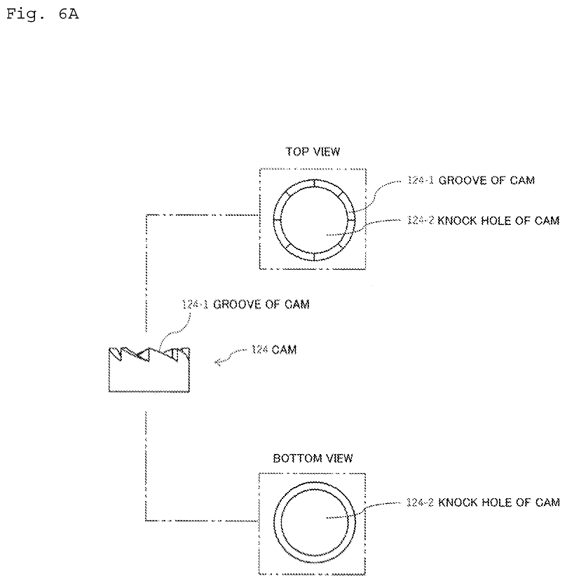

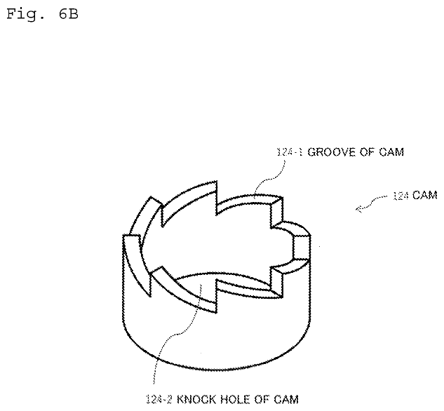

Examples of the configuration of the cam are shown in FIGS. 6A and 6B. FIG. 6A is a front view, a top view and a bottom view of the cam, and FIG. 6B is a perspective view of the cam. In FIG. 3, FIG. 6A and FIG. 6B, the cam 124 has a cylindrical shape in which the knock rod 115 reciprocates in the knock hole 124-2 of the internal cam, and is fixed inside the housing 140. A cam groove 124-1 is formed in an annular shape on the end face on the side of the blade 123. The groove 124-1 of the cam has a sawtooth shape. The period of the groove 124-1 of the cam is the same as that of the groove 115-1 of the knock rod, and is shifted by a half pitch. Since the inclined surface of the groove 124-1 of the cam receives the blade 123 of the rotor 121, the inclined surface has an inclination in the same direction as the inclined surface of the blade 123.

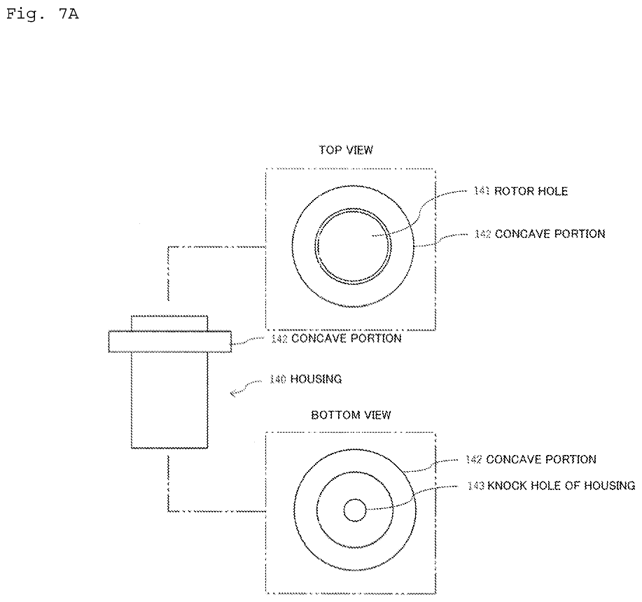

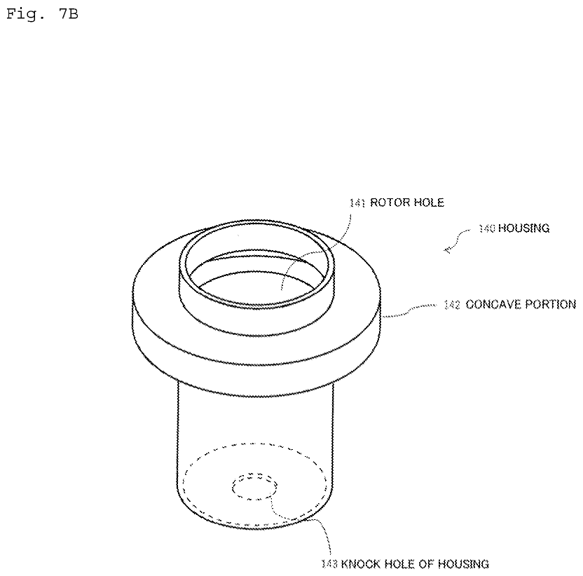

Examples of the configuration of the housing are shown in FIGS. 7A and 7B. FIG. 7A is a front view, a top view and a bottom view of the housing, and FIG. 7B is a perspective view of the housing. In FIGS. 3, 7A and 7B, the housing 140 has a rotor hole 141, a concave portion 142, and a knock hole 143 of the housing. The housing 140 supports the rotor 121 by the rotor hole 141, and stabilizes the rotary motion of the rotor 121. The housing 140 fixes the cam 124 inside. The housing 140 supports an internal knock rod 115 by the knock hole 143 of the housing to stabilize its linear motion. An elastic body 126 is fixed to a part of the housing 140, and the elastic body 126 pushes back the rotor 121 toward the cam 124.

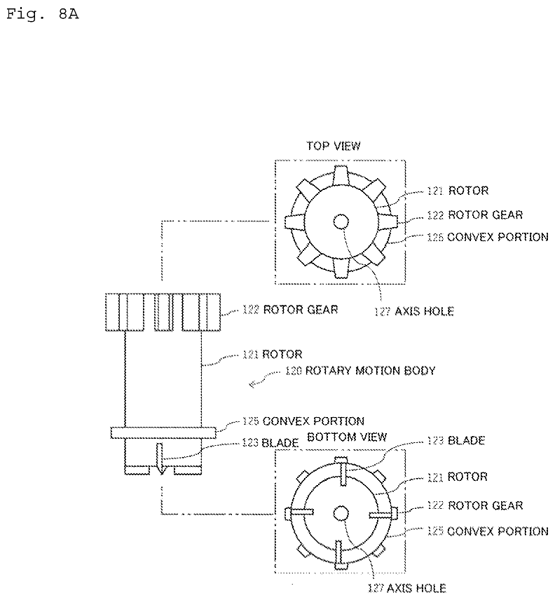

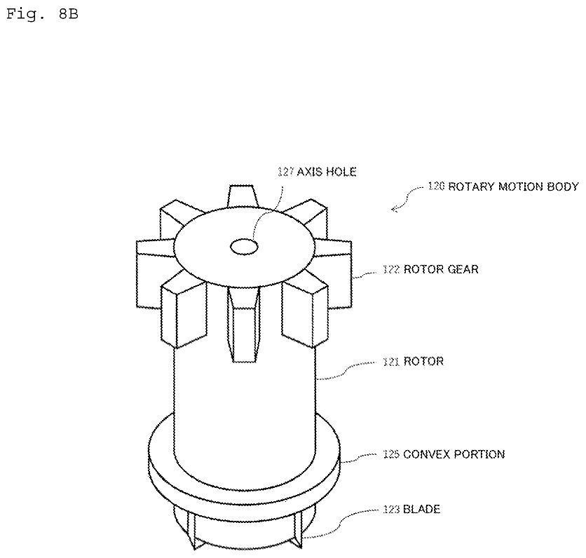

Examples of the configuration of the rotary motion body are shown in FIGS. 8A and 8B. FIG. 8A is a front view, a top view and a bottom view of the rotary motion body, and FIG. 8B is a perspective view of the rotary motion body. In FIGS. 3, 8A and 8B, the rotor 121 rotates around the axis hole 127 in the housing 140. The rotor gear 122 is fixed to a side surface of the rotor 121, and transmits rotation of the rotor 121. The blade 123 is fixed to the end face of the rotor 121 on the knock rod 115 side, and the tip of the knock rod 115 side is a flat slope. The inclined surface of the blade 123 has an inclination in the same direction as the inclined surface of the groove 115-1 of the sawtooth-shaped knock rod and the inclined surface of the groove 124-1 of the sawtooth-shaped cam. It is desirable that the angle of inclination of the slope of the blade 123 is approximately the same as the angle of inclination of the slope of the groove 115-1 of the sawtooth-shaped knock rod and the angle of inclination of the slope of the groove 124-1 of the sawtooth-shaped cam. The convex portion 125 of the rotor has a degree of freedom in the same direction as the linear motion of the knock rod 115 within the range of the internal area of the concave portion 142.

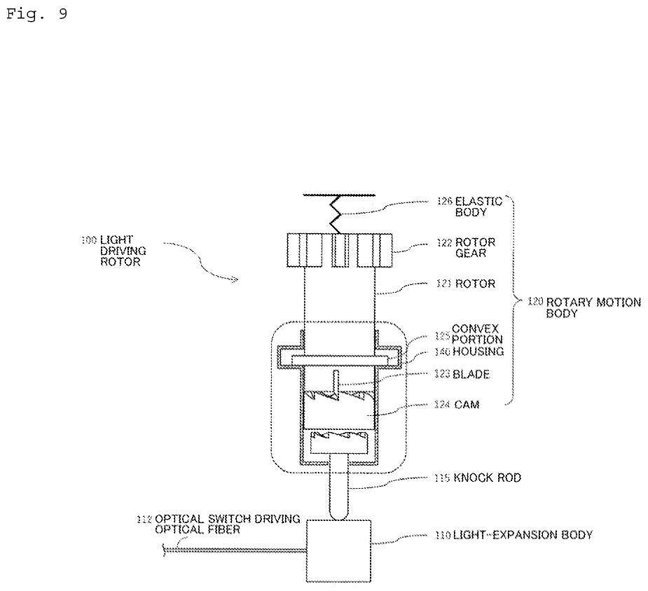

The operation of the light driving rotation unit 100 will be described with reference to FIGS. 9, 10 and 11. In FIGS. 9, 10 and 11, reference numeral 100 denotes a light driving rotation unit, 110 denotes a light-expansion body, 112 denotes an optical switch driving optical fiber, 115 denotes a knock rod, 120 denotes rotary motion body, 121 denotes a rotor, 122 denotes a rotor gear, 123 denotes a blade, 124 denotes a cam, 125 denotes a convex portion, 126 denotes an elastic body, and 140 denotes a housing. In FIGS. 9, 10 and 11, the inside of the housing 140 is seen through only the inside of the dotted line of the light driving rotation unit 100.

In FIG. 9, when the light is not irradiated on the light-expansion body 110, the light-expansion body 110 is contracted. When the light-expansion body 110 is contracted, the knock rod 115 is separated from the blade 123. When the elastic body 126 pushes the rotor 121, the slope of the blade 123 is pressed against the slope of the groove 124-1 of the cam.

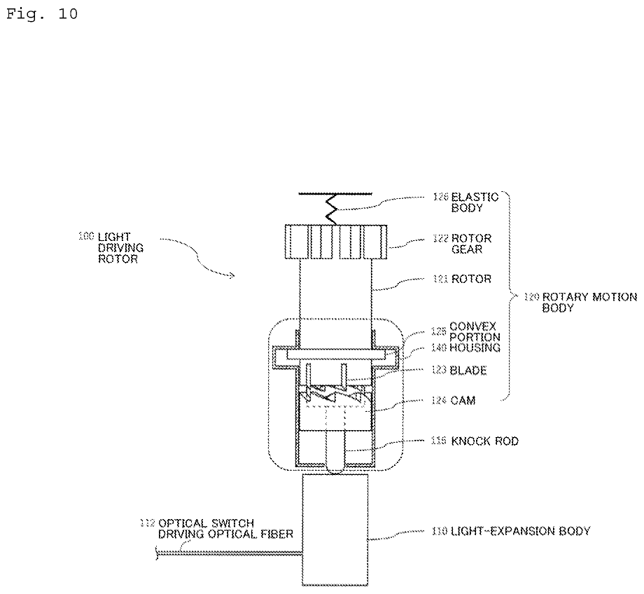

In FIG. 10, when the light-expansion body 110 is irradiated with driving light through the optical switch driving optical fiber 112, the light-expansion body 110 expands. When the light-expansion body 110 expands, the knock rod 115 advances toward the rotor 121. When the inclined surface of the groove 115-1 of the knock rod is pressed against the inclined surface of the blade 123, and the pressed inclined surface of the blade 123 slides on the inclined surface of the groove 115-1 of the knock rod, then the rotor 121 rotates.

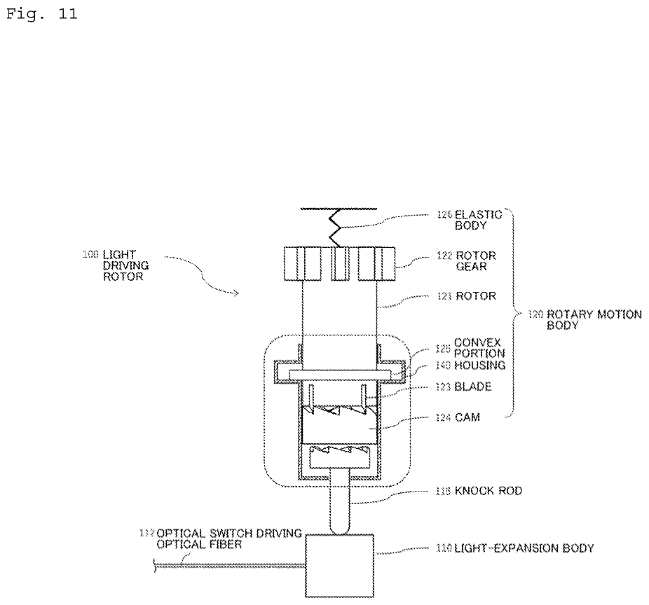

In FIG. 11, when the light for driving to the light-expansion body 110 is interrupted, the light-expansion body 110 contracts. When the light-expansion body 110 contracts, the knock rod 115 retreats from the rotor 121. When the elastic body 126 pushes the rotor 121, the slope of the blade 123 is pressed against the slope of the groove 124-1 of the cam. When the inclined surface of the pressed blade 123 slides on the inclined surface of the groove 124-1 of the cam, the rotor 121 is further rotates. The blades 123 of the rotor 121 are housed in the adjacent grooves. In a series of operations from FIG. 9, the rotor 121 rotates by just one groove of the groove 124-1 of the cam. By repeating the series of operations, the rotor 121 rotates by a constant angle, and rotation at a desired angle can be realized.

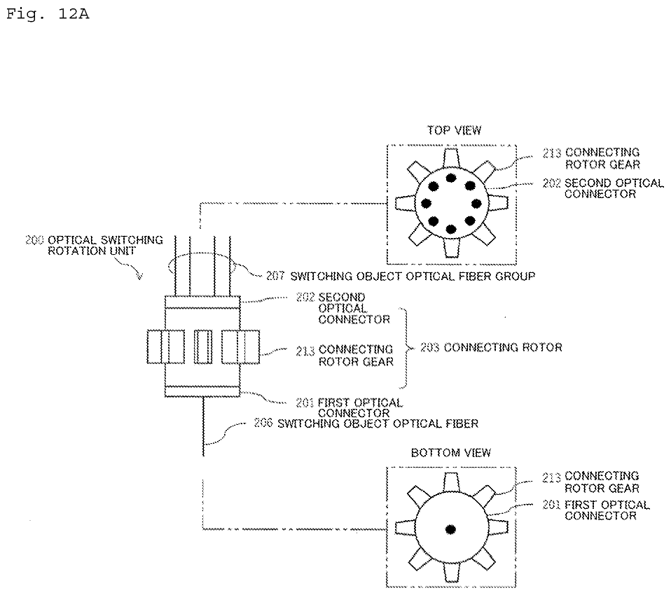

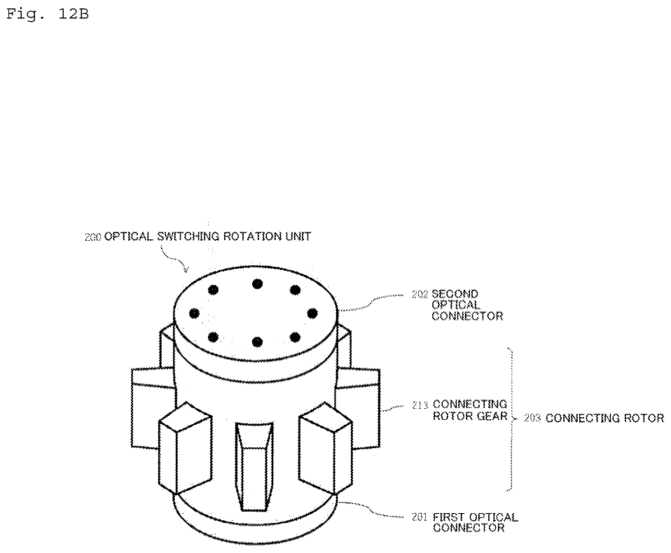

The configuration of the optical switching rotation unit is shown in FIGS. 12A and 12B. FIG. 12A is a front view, a top view, and a bottom view of the optical switching rotation unit, and FIG. 12B is a perspective view of the optical switching rotation unit. In FIG. 12A and FIG. 12B, reference numeral 200 denotes an optical switching rotating unit, 201 denotes a first optical connector, 202 denotes a second optical connector, 203 denotes a connecting rotor, 206 denotes a switching object optical fiber, 207 denotes a switching object optical fiber group, and 213 denotes a connecting rotor gear.

In FIGS. 12A and 12B, the optical switching rotation unit 200 has the first optical connector 201, the second optical connector 202, and the connecting rotor 203. One switching object optical fiber 206 is fixed to the first optical connector 201. A plurality of optical fibers of the switching object optical fiber group 207 are fixed to the second optical connector 202. The connecting rotor 203 rotates around an axis in synchronization with the rotation converted by the rotary motion body 120, and switches/connects one switching object optical fiber 206 fixed to the first optical connector 201 in contact with one end face and one optical fiber in the switching object optical fiber group 207 fixed to the second optical connector 202 in contact with the other end face.

The number of teeth of the optical switching rotation unit 200 in FIGS. 12A and 12B need not coincide with the number of teeth of the rotary motion body 120 in FIG. 8A or the like.

Specifically, the connecting rotor 203 has a connecting rotor gear 213 and a connecting optical path (not shown). The connecting rotor gear 213 causes the connecting rotor 203 to rotate around the axis according to the rotary motion converted by the rotary motion body 120. That is, the connecting rotor gear 213 causes the rotor gear 122 that transmits the rotation of the rotor 121 to rotate the connecting rotor 203 around the axis. The connecting optical path connects the center of rotation of one end face perpendicular to the axis of the connecting rotor 203 and a connection point on a circumference having a predetermined distance as a radius from the center of rotation of the other end face perpendicular to the axis by light.

The first optical connector 201 is in contact with one end face of the connecting rotor 203, and fixes one switching object optical fiber 206 at a position facing the center of rotation of the connecting rotor 203. The second optical connector 202 is in contact with the other end face of the connecting rotor 203, and fixes the plurality of optical fibers of the switching object optical fiber group 207 on a circumference having a predetermined distance as a radius from the center of rotation of the connecting rotor 203. Because the connecting rotor 203 rotates, the connecting optical path of the connecting rotor 203 switches and connects one switching object optical fiber 206 of the first optical connector 201 and one optical fiber among the switching object optical fiber group 207 of the second optical connector 202.

Collimator lenses may be provided respectively at the end points of the connecting optical path of the one switching object optical fiber 206 and the connecting rotor 203 to connect with the collimated light. Further, collimator lenses may be provided respectively at the end points of the plurality of optical fibers of the switching object optical fiber group 207 and the connecting optical path of the connecting rotor 203 to connect with the collimated light. The connection loss can be reduced by connecting through the collimated light.

As described above, the optical switch of the present disclosure can be in no need of power supply, and an optical switch system using the optical switch can operate with low power consumption.

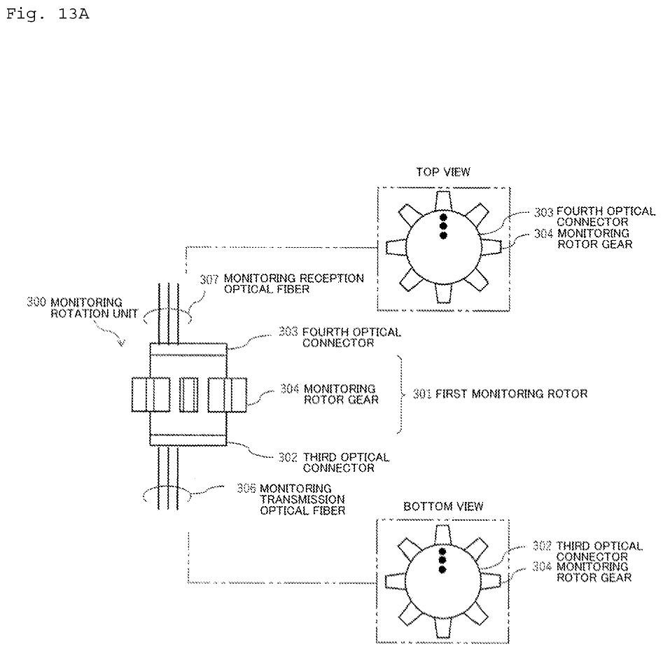

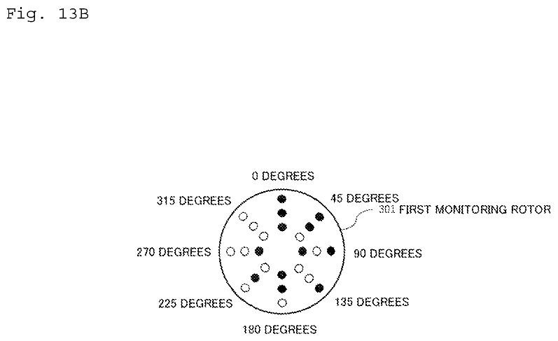

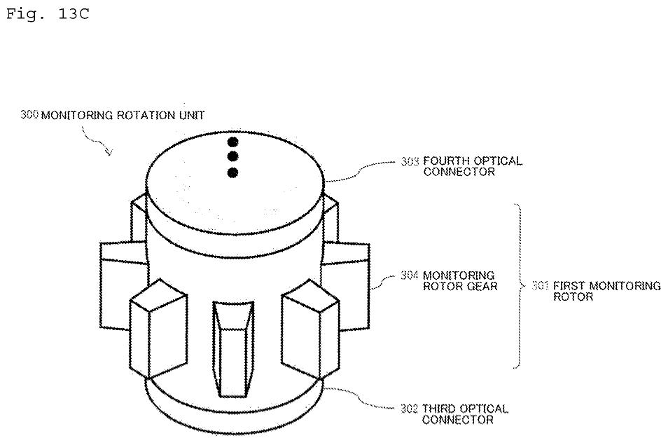

The configuration of the monitoring rotation unit 300 is shown in FIGS. 13A, 13 B and 13 C. FIG. 13A is a front view, a top view, and a bottom view of the light monitoring rotation unit, FIG. 13B is a connection/interruption pattern of the monitoring optical path of the first monitoring rotor, and FIG. 13C is a perspective view of the monitoring rotation unit. In FIG. 13A, FIG. 13B and FIG. 13C, reference numeral 300 denotes a monitoring rotation unit, 301 denotes a first monitoring rotor, 302 denotes a third optical connector, 303 denotes a fourth optical connector, 304 denotes a monitoring rotor gear, 306 denotes a monitoring transmission optical fiber, and 307 denotes a monitoring reception optical fiber.

In the monitoring rotation unit 300, the first monitoring rotor 301 rotates in synchronization with the rotation of the rotary motion body 120, and detects the rotation angle of the connecting rotor 203. The number of teeth of the monitoring rotation unit 300 in FIGS. 13A, 13B and 13C does not necessarily coincide with the number of teeth of the rotary motion body 120 in FIG. 8A or the like.

Specifically, the monitoring rotation unit 300 has a first monitoring rotor 301, a third optical connector 302, a fourth optical connector 303, and a monitoring rotor gear 304. The first monitoring rotor 301 has a plurality of monitoring optical paths (not shown) connecting one end face perpendicular to the axis and the other end face perpendicular to the axis. The first monitoring rotor 301 rotates around an axis according to the rotary motion converted by the rotary motion body 120. The rotary motion is transmitted by a monitoring rotor gear 304 for transmitting the rotation of the rotor 121. The pattern of connection/interruption of the monitoring optical path differs depending on the angle of rotation of the first monitoring rotor 301. A third optical connector 302 is in contact with one end face of the first monitoring rotor 301, and fixes a plurality of monitoring transmission optical fibers 306 for transmitting monitoring light. A fourth optical connector 303 is in contact with the other end face of the first monitoring rotor 301, and fixes a plurality of monitoring reception optical fibers 307 for receiving monitoring light.

Collimator lenses may be provided respectively at the end points of the monitoring optical path of the monitoring transmission optical fiber 306 and the first monitoring rotor 301 to connect with the collimated light. Further, collimator lenses may be provided respectively at the end points of the monitoring optical path of the monitoring reception optical fiber 307 and the first monitoring rotor 301 to connect with the collimated light. The connection loss can be reduced by connecting through the collimated light.

By the rotation of the first monitoring rotor 301, the pattern of connection/interruption of each light from the plurality of monitoring transmission optical fibers 306 to the plurality of monitoring reception optical fibers 307 is uniquely changed. For example, in FIG. 13B, the first monitoring rotor 301 is divided into eight parts in units of 45 degrees in the rotation direction of the axis. In the case of the unit of 45 degrees, the unit is divided into eight parts of 0, 45, 90, 135, 180, 225, 270 and 315 degrees. Three optical fibers are used for the transmission optical fiber 306 for monitoring, and the three transmission optical fibers 306 for monitoring are fixed at a position of 0 deg of the end face of the third optical connector 302. Similarly, three optical fibers are used for the monitoring reception optical fiber 307, and the three monitoring reception optical fibers 307 are fixed at the position of 0 degree on the end face of the fourth optical connector 303. In the first monitoring rotor 301, the patterns of connection and interruption of the three monitoring transmission optical fibers 306 and the three monitoring reception optical fibers 307 are uniquely different according to the rotation angle.

When the first monitoring rotor 301 rotates in units of 45 degrees, the patterns of connection and interruption from the three monitoring transmission optical fibers 306 to the three monitoring reception optical fibers 307 change uniquely. When the connection is set to 1, the interruption is set to 0, the black circle is set to “1”, and the white circle is set to “0” in FIG. 13B, eight (=3 bits) of 111, 011, 101, 001, 110, 010, 100 and 000 can be detected from the center toward the peripheral edge, respectively depending on the angles of 0, 45, 90, 135, 180, 225, 270 and 315 degrees.

For example, in the case of the first monitoring rotor 301 rotating in units of 10 degrees, the first monitoring rotor 301 is divided into 36 parts at intervals of 10 degrees in order to monitor 36 kinds of states, six monitoring optical paths are arranged at the first monitoring rotor 301, and six monitoring transmission optical fibers 306 and six monitoring reception optical fibers 307 are required. The number of monitoring optical paths of the first monitoring rotor 301, the number of monitoring transmission optical fibers 306 and monitoring reception optical fibers 307 may be determined in accordance with the rotation angle unit to be detected.

The first monitoring rotor 301 is synchronized with the rotation of the rotor 121, and the connecting rotor 203 is also synchronized with the rotation of the rotor 121. Therefore, the rotation angle of the connecting rotor 203 can be known from the rotation angle detected by the monitoring rotation unit 300, and as a result, the optical switching rotation unit 200 can monitor that the switching object optical fiber 206 and which optical fiber of the switching object optical fiber group 207 and are connected.

As described above, the optical switch including the monitoring rotation unit of the present disclosure can be in no need of power supply, and the optical switch system using the optical switch can operate with low power consumption.

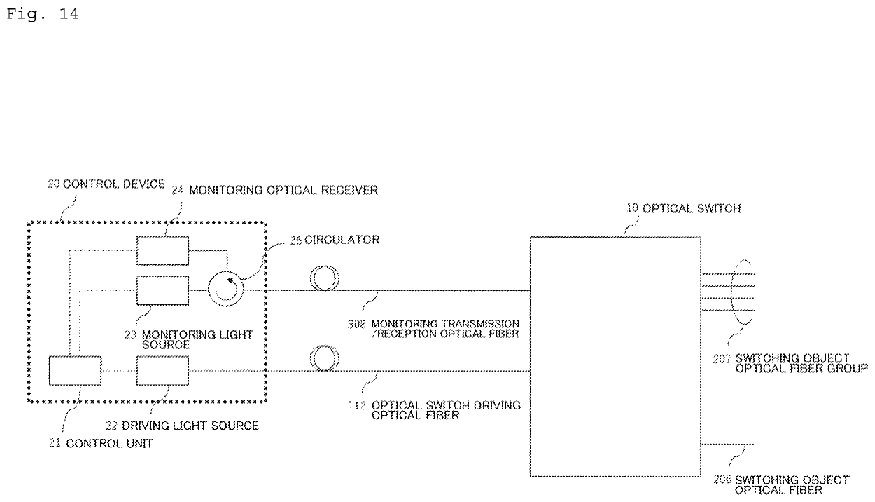

An alternative configuration of the optical switch system of the present disclosure is shown in FIG. 14. In FIG. 14, reference numeral 10 denotes an optical switch, 112 denotes an optical switch driving optical fiber, 20 denotes a control device, 21 denotes a control unit, 22 denotes a driving light source, 23 denotes a monitoring light source, 24 denotes a monitoring light receiver, 25 denotes a circulator, 206 denotes a switching object optical fiber, 207 denotes a switching object optical fiber group, and 308 denotes a monitoring transmission/reception optical fiber.

The optical switch system includes the optical switch 10 and the control device 20. The control device 20 has the control unit 21, the driving light source 22, the monitoring light source 23, the monitoring optical receiver 24, and the circulator 25. The optical switch system of FIG. 14 differs from the optical switch system of FIG. 1 in that the control device 20 further has the circulator 25 and uses the monitoring transmission/reception optical fiber 308 for monitoring the optical switch 10.

The control unit 21 causes the monitoring light source 23 to transmit monitoring light. The monitoring light source 23 supplies monitoring light to the optical switch 10 through the circulator 25 and the monitoring transmission/reception optical fiber 308. The monitoring optical receiver 24 receives monitoring light from the optical switch 10 via the monitoring transmission/reception optical fiber 308 and the circulator 25. The control unit 21 receives a reception signal from the monitoring optical receiver 24, and monitors whether the optical switch 10 operates as instructed.

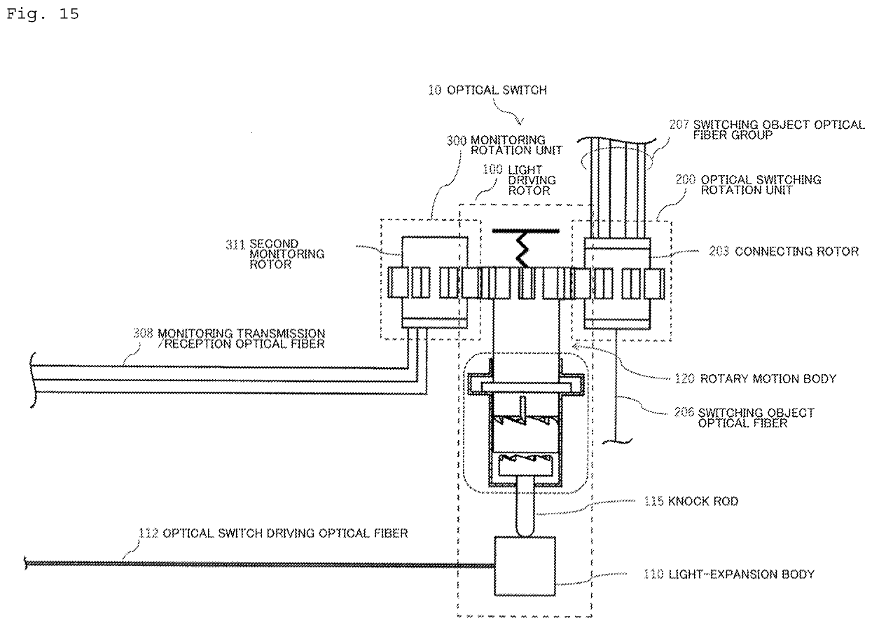

An alternative configuration of the optical switch of the present disclosure is shown in FIG. 15. In FIG. 15, reference numeral 10 denotes an optical switch, 100 denotes a light driving rotation unit, 110 denotes a light-expansion body, 112 denotes an optical switch driving optical fiber, 115 denotes a knock rod, 120 denotes rotary motion body, 200 denotes a optical switching rotation unit, 203 denotes a connecting rotor, 206 denotes a switching object optical fiber, 207 denotes a switching object optical fiber group, 300 denotes a monitoring rotation unit, 311 denotes a second monitoring rotor, and 308 denotes a transmission/reception optical fiber. The light driving rotation unit 100 and the optical switching rotation unit have the same configuration as the optical switch shown in FIG. 2. The configuration of the monitoring rotation unit 300 differs from that of the optical switch of FIG. 2. By the way, in FIG. 15, the inside of the housing 140 is seen through only the inside of the dotted line of the light driving rotation unit 100.

In a monitoring rotation unit 300 of the optical switch, when a component in the light driving rotation unit 100 rotates by a constant angle, the rotation is transmitted to the monitoring rotation unit 300, and the second monitoring rotor 311 of the monitoring rotation unit 300 rotates by a constant angle. When light is input to the monitoring rotation unit 300 from the monitoring transmission/reception optical fiber 308, the rotation angle of the connecting rotor 203 in the optical switching rotation unit 200 can be detected depending on how the light is reflected/interrupted and re-input to the monitoring transmission/reception optical fiber 308. Therefore, the control device 20 can monitor whether the optical switch 10 connects or disconnects between the switching object optical fiber 206 and which optical fiber in the switching object optical fiber group 207 as instructed.

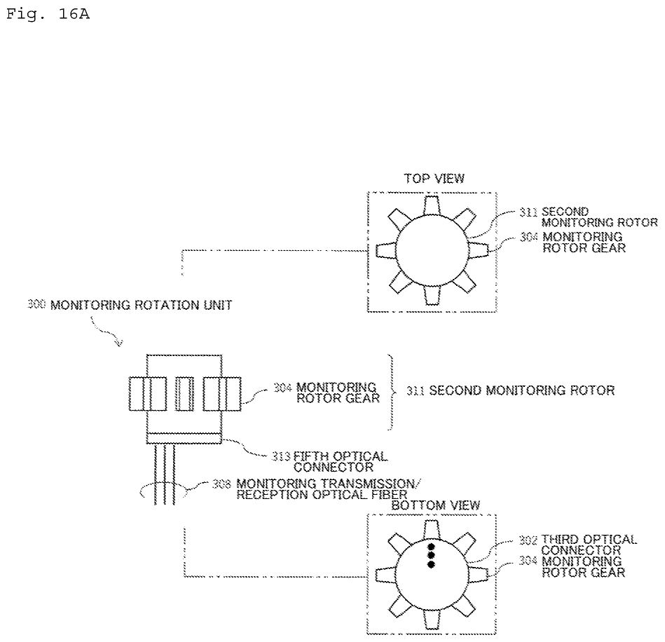

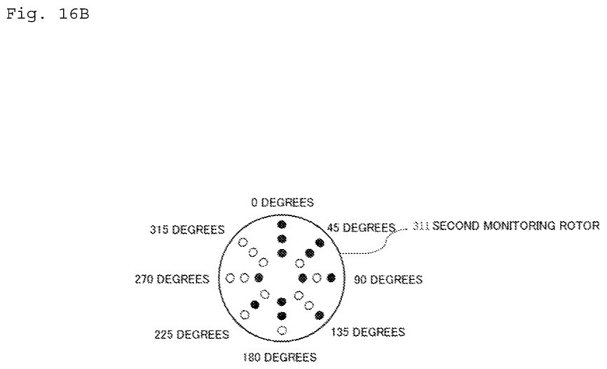

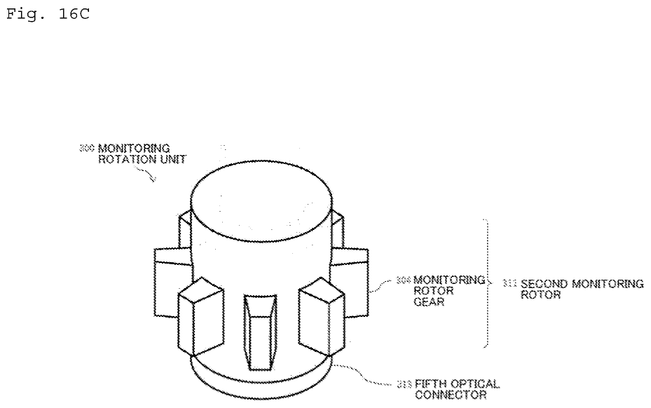

The configuration of the monitoring rotation unit 300 is shown in FIGS. 16A, 16B and 16C. FIG. 16A is a front view, a top view and a bottom view of the light monitoring rotation unit, FIG. 16B is a reflection/interruption pattern of the second monitoring rotor, and FIG. 16C is a perspective view of the monitoring rotation unit. In FIG. 16A, FIG. 16B and FIG. 16C, reference numeral 300 denotes a monitoring rotation unit, 311 denotes a second monitoring rotor, 313 denotes a fifth optical connector, 304 denotes a monitoring rotor gear, and 308 denotes a monitoring transmission/reception optical fiber.

The monitoring rotation unit 300 rotates in synchronization with the rotation of the rotary motion body 120, and detects a rotation angle of the rotary motion body 120. The number of teeth of the monitoring rotation unit 300 in FIGS. 16A, 16B and 16C does not need to coincide with the number of teeth of the rotary motion body 120 in FIG. 8A or the like.

In the monitoring rotation unit 300, the second monitoring rotor 311 rotates in synchronization with the rotation of the rotary motion body 120, and detects the rotation angle of the connecting rotor 203.

Specifically, the monitoring rotation unit 300 has the second monitoring rotor 311, the fifth optical connector 313, and the monitoring rotor gear 304. The second monitoring rotor 311 has a reflecting plate having a plurality of reflecting/interrupting portions (not shown) on one end face perpendicular to an axis. The second monitoring rotor 311 rotates around the axis according to the rotary motion converted by the rotary motion body 120. The rotary motion is transmitted by the monitoring rotor gear 304 that transmits the rotation of the rotor 121. The patterns of reflection/interruption are different depending on the angle of rotation of the second monitoring rotor 311. The fifth optical connector 313 is in contact with one end face of the second monitoring rotor 311, and fixes a plurality of monitoring transmission/reception optical fibers 308 that transmits/receives the monitoring light.

A collimator lens may be provided at the end point of the monitoring transmission/reception optical fiber 308 to reflect/interrupt the collimated light. The connection loss can be reduced by connecting through the collimated light.

By the rotation of the second monitoring rotor 311, the reflection/interruption pattern of light from the plurality of the monitoring transmission/reception optical fibers 308 is uniquely changed. For example, in FIG. 16B, the second monitoring rotor 311 is divided respectively into eight parts in units of 45 degrees in the rotation direction of the axis. In the case of the unit of 45 degrees, the unit is divided into eight parts of 0, 45, 90, 135, 180, 225, 270 and 315 degrees. Three optical fibers are used for the monitoring transmission/reception optical fibers 308, and the three monitoring transmission/reception optical fibers 308 are fixed at a position of 0 degree of the end face of the fifth optical connector 313. In the second monitoring rotor 311, the reflection/interruption patterns of the three monitoring transmission/reception optical fibers 308 are uniquely different according to the rotation angle.

When the second monitoring rotor 311 rotates in units of 45 degrees, the reflection/interruption patterns are changed uniquely with respect to the three monitoring transmission/reception optical fibers 308. When reflection is set to 1, interrupting is set to 0, and black circles are set to “1” and white circles are set to “0” in FIG. 16B, the angle of the black circles is set to 0, and the angle of the white circles is set to 0, eight (=3 bits) of 111, 011, 101, 001, 110, 010, 100 and 000 can be detected from the center toward the peripheral edge, respectively depending on the angles of 0, 45, 90, 135, 180, 225, 270 and 315 degrees.

In the case where the light is reflected with respect to the three monitoring transmission/reception optical fibers 308, the light for monitoring can be returned to the monitoring transmission/reception optical fiber 308, by reflecting the light for monitoring with a mirror from the monitoring transmission/reception optical fiber 308 in the second monitoring rotor 311. In the case where the light is interrupted with respect to the three monitoring transmission/reception optical fibers 308, the light may be prevented from returning to the monitoring transmission/reception optical fibers 308, by no reflecting, absorbing, or reflecting toward another direction the monitoring light from the monitoring transmission/reception optical fibers 308 in the second monitoring rotor 311.

The decision about the number of reflection/interruption of the second monitoring rotor 311 and the number of monitoring transmission/reception optical fibers 308 in accordance with the detected rotation angle unit is the same as the case in FIG. 13A.

The second monitoring rotor 311 is synchronized with the rotation of the rotor 121, and the connecting rotor 203 is also synchronized with the rotation of the rotor 121. Therefore, the rotation angle of the connecting rotor 203 can be known from the rotation angle detected by the monitoring rotation unit 300, and as a result, the optical switching rotation unit 200 can monitor that the switching object optical fiber 206 is connected to which optical fiber of the switching object optical fiber group 207.

As described above, the optical switch including the monitoring rotation unit of the present disclosure can be in no need of power supply, and the optical switch system using the optical switch can operate with low power consumption.

### INDUSTRIAL APPLICABILITY

The present disclosure is applicable to the optical communications industry.

### REFERENCE SIGNS LIST

10: Optical switch
20: Control device
21: Control unit
22: Driving light source
23: Monitoring light source
24: Monitoring optical receiver
25: Circulator
100: Light driving rotation unit
110: Light-expansion body
110-1: Light-expansion member
111: Lever
112: Optical switch driving optical fiber
115: Knock rod
115-1: Groove of knock rod
115-2: Pressing unit
120: Rotary motion body
121: Rotor
122: Rotor gear
123: Blade
124: Cam
124-1: Groove of cam
124-2: Knock hole of cam
125: Convex portion
126: Elastic body
127: Axis hole
140: Housing
141: Rotor hole
142: Concave portion
143: Knock hole of housing
200: Optical switching rotation unit
201: First optical connector
202: Second optical connector
203: Connecting rotor
206: Switching object optical fiber
207: Switching object optical fiber group
213: Switching rotor gear
300: Monitoring rotation unit
301: First monitoring rotor
302: Third optical connector
303: Fourth optical connector
304: Monitoring rotor gear
306: Monitoring transmission optical fiber
307: Monitoring reception optical fiber
308: Monitoring transmission/reception optical fiber
311: Second monitoring rotor
313: Fifth optical connector

1. An optical switch, comprising:
a light driving rotation unit including:
a light-expansion body which expands by irradiating light and contracts by interrupting light;
a knock rod for converting expansion/contraction of the light-expansion body into reciprocating linear motion by a constant distance; and
a rotary motion body for correspondingly converting reciprocating linear motion by the constant distance of the knock rod into rotating rotary motion by a constant angle; and
a optical switching rotation unit including:
a first optical connector to which one switching object optical fiber is fixed;
a second optical connector to which an optical fiber of a switching object optical fiber group is respectively fixed; and
a connecting rotor for rotating around an axis in synchronization with rotation converted by the rotary motion body, and for switching/connecting one switching object optical fiber fixed to the first optical connector in contact with one end face and one optical fiber in the switching object optical fiber group fixed to the second optical connector in contact with other end face.

2. The optical switch according to claim 1, wherein
the rotary motion body including:
a rotor for rotating around an axis within a housing;
a rotor gear fixed to side face of the rotor, and for transmitting the rotation of the rotor;
a blade fixed to end face of the knock rod side of the rotor, and having a tip with a flat slope at the knock rod side;
a cylindrical-shaped cam fixed to within the housing, having a slope of a sawtooth groove with an annular shape provided to an end face of the cylindrical-shaped blade side, and receiving the slope of the blade with the slope which has inclination of the same direction as the slope of the blade; and
an elastic body fixed to the housing, and pressing back the rotor toward the cam; and
the knock rod for reciprocating in the cylindrical-shaped inside of the cam and including a sawtooth groove at the end face of the blade side with an annular shape, which is shifted by a half pitch at the same period as the sawtooth groove of the cam, and has a slope inclined in the same direction as the slope of the blade; wherein
when the light-expansion body contracts, the slope of the blade is pressed against on the slope of the sawtooth groove of the cam by the elastic body;
when the light-expansion body expands, the knock rod progresses toward the rotor, the slope of the sawtooth groove of the knock rod is pressed against the slope of the blade, and the pressed slope of the blade slides on the slope of the teeth of the sawtooth groove of the knock rod, thereby the rotor rotates; and
when the light-expansion body shifts from expansion to contraction, the knock rod retreats from the rotor, the rotor pressed back by the elastic body goes to the cam, the slope of the blade is pressed against the slope of the sawtooth groove of the cam, and the pressed slope of the blade slides on the slope of the teeth of the sawtooth groove of the cam, thereby the rotor rotates.

3. The optical switch according to claim 1, wherein the light-expansion body is made of a black material or a material containing air bubbles therein.

4. The optical switch according to claim 1, wherein
the connecting rotor including:
a connecting rotor gear for rotating around an axis according to the rotary motion converted by the rotary motion body; and
a connecting optical path for connecting a rotation center of one end face perpendicular to the axis and a connecting point arranged on a circumference having a radius of a predetermined distance from the rotation center of other end face perpendicular to the axis; wherein
the first optical connector is in contact with one end face of the connecting rotor, and fixes the one switching object optical fiber to a position opposed the rotation center of the connecting rotor; and
the second optical connector is in contact with other end face of the connecting rotor, and respectively fixes an optical fiber in the switching object optical fiber group on a circumference having a radius of a predetermined distance from the rotation center of the connecting rotor; wherein
when the connecting rotor rotates, the connecting optical path switches/connects the one switching object optical fiber of the first optical connector and one optical fiber in the switching object optical fiber group of the second optical connector.

5. The optical switch according to claim 1, further comprising a monitoring rotation unit which rotates in synchronization with the rotation of the rotary motion body and detects an angle of rotation of the connection rotor.

6. The optical switch according to claim 5, wherein
the monitoring rotation unit including:
a first monitoring rotor rotates around an axis according to the rotary motion converted by the rotary motion body, and has a plurality of monitoring optical paths which connect one end face perpendicular to the axis and other end face perpendicular to the axis and in which connection/interruption patterns are different depending on the angle of the rotation;
a third optical connector which is in contact with one end face of the first monitoring rotor, and fixes a plurality of monitoring transmission optical fibers for transmitting monitoring light; and
a fourth optical connector which is in contact with other end face of the first monitoring rotor, and fixes a plurality of monitoring reception optical fibers for receiving monitoring light; wherein
when the first monitoring rotor rotates, connection/interruption patterns of each light from the plurality of monitoring transmission optical fibers to the plurality of monitoring reception optical fibers uniquely change.

7. The optical switch according to claim 5, wherein
the monitoring rotation unit including:
a second monitoring rotor which rotates around the axis according to the rotary motion converted by the rotary motion body, and has a reflection plate, at one end face perpendicular to the axis, whose reflection/interruption patterns are different depending on an angle of the rotation; and
a fifth optical connector which is in contact with one end face of the second monitoring rotor, and fixes a plurality of monitoring transmission/reception optical fibers for transmitting/receiving the monitoring light; wherein
when the second monitoring rotor rotates, reflection/non-reflection patterns uniquely change of each light in the plurality of monitoring transmission/reception optical fibers.

8. An optical switch system, comprising:
the optical switch according to claim 1; and a control device includes a driving light source for supplying light causing the light-expansion body to expand and a control unit for instructing irradiation/interruption to the driving light source.
